(19) United States
(12) Patent Application Publication
(10) Pub. No.: US 2025/0018529 A1
(43) Pub. Date: Jan. 16, 2025

(54) Tool Interface Device, in Particular Insertion Tool Hub

(71) Applicant: Robert Bosch GmbH, Stuttgart (DE)

(72) Inventors: Daniel Barth, Leinfelden-Echterdingen (DE); Laurent Quebatte, Visp (CH)

(21) Appl. No.: 18/713,682

(22) PCT Filed: Oct. 26, 2022
(86) PCT No.: PCT/EP2022/079858

§ 371 Date: May 27, 2024

(30) Foreign Application Priority Data
Nov. 30, 2021 (DE) 10 2021 213 510.2
May 11, 2022 (DE) 10 2022 204 599.8

(51) Int. Cl. B24B 45/00; B24B 23/02

(52) U.S. Cl. CPC B24B 45/006; B24B 23/028

(57) ABSTRACT

A tool interface device for an insertion tool for connecting the insertion tool to a tool holder of a machine tool includes at least one connection interface for a frictional and/or form-fitting connection to a quick clamping device of the tool holder. The connection interface includes at least one axial securing element for axial securing to the quick clamping device. The connection interface has at least one centering element with a centering contour that rests against the quick clamping device when the connection interface is disposed on the quick clamping device and that is disposed at an angle relative to a delimiting contour of the connection interface that delimits a through-opening of the connection interface.

### PRIOR ART

DE 10 2017 213 668 A1 already discloses a tool interface device, in particular an insertion tool hub, for an insertion tool for connecting the insertion tool to a tool holder of a machine tool. The known tool interface device comprises at least one connection interface, in particular disposed completely in a hub plane, for a frictional and/or form-fitting connection to a quick clamping device of the tool holder, wherein the connection interface comprises at least one axial securing element, in particular a clamping face, for axial securing to the quick clamping device.

### DISCLOSURE OF THE INVENTION

The invention is based on a tool interface device, in particular an insertion tool hub, for an insertion tool for connecting the insertion tool to a tool holder of a machine tool, in particular a portable machine tool, with at least one connection interface, in particular disposed completely in a hub plane, for a frictional and/or form-fitting connection to a quick clamping device of the tool holder, wherein the connection interface comprises at least one axial securing element, in particular a clamping face, for axial securing to the quick clamping device.

It is proposed that the connection interface has at least one centering element, wherein a centering contour, in particular a centering face, of the centering element, which in a state of the connection interface disposed on the quick clamping device rests against the quick clamping device, is disposed at an angle relative to a delimiting contour, in particular an outer delimiting face, of the connection interface, which delimits a through-opening of the connection interface. The design of the tool interface device according to the invention makes it easy to achieve a self-centering function in a state of the tool interface device secured to the quick clamping device. Advantageously, when the tool interface device is secured to the quick clamping device, a largely automatic self-centering function can be implemented as a result of a torque acting on the tool interface device. An advantageously precise alignment of the tool interface device and thus of an insertion tool provided with the tool interface device on the quick clamping device can be achieved. It is advantageous to counteract an imbalance when the tool interface device rotates. It can advantageously enable safe and precise operation of a tool interface device and thus of an insertion tool provided with the tool interface device on a machine tool.

The centering element is preferably disposed adjacent to the outer delimiting contour of the connection interface that delimits the through-opening of the connection interface, particularly when viewed along the peripheral direction of the connection interface. The peripheral direction preferably runs in a plane extending at least essentially perpendicular to an axis of rotation of the connection interface. The axis of rotation of the connection interface is an axis about which the connection interface, in particular the tool interface device, can be driven to rotate or oscillate in a state in which it is fixed to the quick clamping device. The expression “essentially perpendicular” is intended in particular to define an orientation of a direction relative to a reference direction, wherein the direction and the reference direction, in particular viewed in a plane, enclose an angle of 90° and the angle has a maximum deviation of in particular less than 8°, advantageously less than 5° and particularly advantageously less than 2°. The centering contour is preferably disposed at an angle relative to the outer delimiting contour. Preferably, the centering contour, in particular the centering face, forms an angle with the outer delimiting contour, in particular the delimiting face, which is in particular less than 180°, preferably less than 160° and most preferably less than 120°, in particular on a side of the centering contour and the outer delimiting contour facing the through-opening. Preferably, the centering contour, in particular the centering face, forms an angle with an axis extending at least essentially perpendicular to the outer delimiting contour, in particular to the outer delimiting face, which is in particular less than 90°. The outer delimiting contour is preferably designed as a pitch circle contour. The through-opening of the connection interface is preferably provided for a feed-through of the quick clamping device or alternatively of an output threaded spindle, in particular one already known to a person skilled in the art. “Provided” is understood in particular as meaning specifically adapted, specifically designed and/or specifically equipped. In particular, the phrase “an object being provided for a specific function” is intended to mean that the object fulfills and/or performs this specific function in at least one application—and/or operating state. The connection interface has an inner delimiting contour that delimits the through-opening. The inner delimiting contour is preferably designed as a pitch circle contour. In particular, the outer delimiting contour is disposed on a circle that has a diameter that is larger than the diameter of a circle on which the inner delimiting contour is disposed. The inner delimiting contour is preferably disposed on a circle with a maximum diameter of 16 mm. The outer delimiting contour is preferably disposed on a circle that has a maximum diameter of 21.5 mm or, if the insertion tool is designed as a circular saw blade, a maximum diameter of 36.5 mm. The outer delimiting contour is preferably disposed concentrically to the inner delimiting contour around the axis of rotation. The centering element is preferably disposed between the inner delimiting contour and the outer delimiting contour, particularly when viewed along a radial direction. The centering element is preferably disposed at a distance relative to the inner delimiting contour, particularly when viewed along the radial direction.

The centering face of the centering element preferably runs at least essentially parallel to the axis of rotation. In particular, a main extension plane of the axial securing element, in particular the clamping face, extends transversely, in particular at least essentially perpendicularly, to the axis of rotation. The main extension plane of the axial securing element, in particular the clamping face, preferably extends transversely, in particular at least essentially perpendicularly, to the centering face of the centering element. The axial securing element is preferably designed as a clamping extension, in particular as a clamping wing. The axial securing element extends in a plane that is at least essentially perpendicular to the axis of rotation, preferably starting from the outer delimiting contour to the inner delimiting contour. The connection interface preferably comprises two, in particular three and preferably four axial securing elements, which are disposed offset relative to each other along the peripheral direction. However, it is also conceivable that the connection interface comprises a number of axial securing elements other than two, three or four, such as six, eight, twelve or the like. In particular, the axial securing elements are evenly distributed along the peripheral direction. However, it is also conceivable that the connection interface has a different number of axial securing elements than two, three or four and/or that the axial securing elements are unevenly distributed along the peripheral direction. The axial securing element(s) is/are preferably provided for a frictional and/or non-positive connection along a direction running at least essentially parallel to the axis of rotation with the quick clamping device.

Preferably, the quick clamping device is fixed, in particular non-rotatable, on the machine tool, in particular on an output spindle of an output unit of the machine tool. Alternatively, it is conceivable that the quick clamping device is detachably disposed on the machine tool, in particular on the output spindle. The quick clamping device is preferably provided for fastening the tool interface device to the machine tool, in particular without tools. The tool interface device is preferably designed as an insertion tool hub. The tool interface device can be driven by the output spindle, preferably rotating or oscillating, in particular in a state of the tool interface device secured to the machine tool by means of the quick clamping device. An axial securing of the tool interface device represents in particular a securing of the tool interface device along an axial direction of an output axis of the output spindle. The quick clamping device has, in particular when viewed in a plane extending at least essentially perpendicular to the output axis, an outer contour which is designed to correspond with a contour of the connection interface which results from a course of the outer and inner delimiting contour along the peripheral direction.

Preferably, the quick clamping device comprises at least one clamping device for axially securing the tool interface device to the output spindle. The clamping device preferably comprises at least one clamping jaw, preferably at least two clamping jaws. A clamping jaw is to be understood in particular as a rotatable, pivotable and/or displaceable element which has at least one active face for transmitting a clamping force effect, in particular along an axial direction of the output axis of the output spindle, to the tool interface device, in particular to the axial securing element(s). Preferably, the clamping device is disposed on the output unit so that it cannot be lost. Preferably, the clamping jaws are movable relative to each other, in particular pivotable relative to each other about a pivot axis of the clamping device, in particular on the output spindle. Preferably, the clamping jaws have a common axis of movement, in particular a common pivot axis. However, it is also conceivable that the clamping jaws have different axes of movement, in particular pivot axes that run at least essentially parallel to each other. The axis of movement, in particular the pivot axis, of the clamping device, in particular the clamping jaws, preferably runs in a plane that is transverse, in particular at least essentially perpendicular, to the output axis. Preferably, the clamping jaws are mounted in motion-coupled bearings. For example, the clamping jaws each have a toothing or the like that mesh with each other. However, other configurations for coupling a movement of the clamping jaws are also conceivable, which would appear to a person skilled in the art to be useful.

The clamping jaws can be pivoted relative to each other, in particular about the pivot axis, at an angle of up to 50°, preferably up to 40°, preferably up to 30°, particularly preferably up to 20°. The clamping jaw or the clamping jaws can in particular have at least two states, in particular a fastened state or a released state. In a fastened state, the clamping jaws are extended in a radial direction away from the output axis, in particular in such a way that the clamping jaws have a maximum radial extension relative to each other in an extended state. In a fastened state, the clamping jaws are connected to the tool interface device, in particular in engagement, in particular as a result of a movement of the clamping jaws in a direction away from the output axis, wherein the tool interface device can be held frictionally and/or non-positively on the quick clamping device by means of the clamping jaws. In a fastened state, the tool interface device is form-fittingly connected to the quick clamping device in the axial direction of the output axis. In a released state, the clamping device, in particular the clamping jaws, is retracted in a radial direction to the output axis, in particular in such a way that the clamping device, in particular the clamping jaws, has a minimum radial extension along a direction running at least essentially perpendicular to the output axis, which is smaller than a minimum transverse extension, in particular minimum diameter, of the through-opening of the connection interface. Preferably, the clamping device, in particular the clamping jaws, can be transferred from a released state to a fastened state by inserting the tool interface device in the axial direction of the output axis into the quick clamping device.

Preferably, the output unit is intended to transmit a rotational and/or oscillating movement about the output axis to an insertion tool, which is fixed to the output unit by means of the quick clamping device and comprises the tool interface device. Preferably, the output unit is effectively connected to a drive unit of the machine tool in a manner already known to a person skilled in the art, in particular via at least one drive pinion of the drive unit. In particular, the output unit comprises at least one sleeve and/or at least one hollow shaft, in particular a hollow spindle, which forms the output spindle. The rotational and/or oscillating movement of the output unit can preferably be generated as a result of interaction between the output unit and the drive unit of the machine tool, which comprises at least one electric motor. In a state of the tool interface device disposed on the quick clamping device, the rotational and/or oscillating movement can preferably be transmitted to the tool interface device, in particular to the centering element and/or to a torque transmission element, by means of a rotary entrainment element of the quick clamping device.

Furthermore, it is proposed, in particular in at least one exemplary embodiment, that the connection interface comprises, in particular in addition to the centering element, at least one torque transmission element for transmitting a torque in a state of the connection interface disposed on the quick clamping device, wherein the torque transmission element has a torque transmission contour, in particular a torque transmission face, which rests against the quick clamping device in a state of the connection interface disposed on the quick clamping device, wherein the connection interface has at least the one centering element, in particular adjoining the torque transmission element along a peripheral direction of the connection interface, wherein the centering contour, in particular the centering face, of the centering element, which rests against the quick clamping device in a state of the connection interface disposed on the quick clamping device, is disposed at an angle relative to the torque transmission contour, in particular relative to the torque transmission face, of the torque transmission element. The torque transmission face of the torque transmission element preferably runs at least essentially parallel to the axis of rotation. The main plane of extension of the axial securing element, in particular the clamping face, preferably extends transversely, in particular at least essentially perpendicular to the torque transmission face of the torque transmission element. The torque transmission element can be provided independently of the centering element or in conjunction with the centering element to transmit a torque in a state of the connection interface disposed on the quick clamping device. The design of the tool interface device according to the invention makes it easy to achieve a self-centering function in a state of the tool interface device secured to the quick clamping device. Advantageously, when the tool interface device is secured to the quick clamping device, a largely automatic self-centering function can be implemented as a result of a torque acting on the tool interface device. An advantageously precise alignment of the tool interface device and thus of an insertion tool provided with the tool interface device on the quick clamping device can be achieved. It is advantageous to counteract an imbalance when the tool interface device rotates. It can advantageously enable safe and precise operation of a tool interface device and thus of an insertion tool provided with the tool interface device on a machine tool.

Furthermore, it is proposed that the centering contour, in particular the centering face, of the centering element and the torque transmission contour, in particular the torque transmission face, of the torque transmission element enclose an angle that is smaller than 180°, in particular smaller than 150°. In particular, the centering contour, in particular the centering face, of the centering element and the torque transmission contour, in particular the torque transmission face, of the torque transmission element include an angle that is smaller than 140° and preferably has a value from a value range of 90° to 135°. Preferably, the centering contour, in particular the centering face, of the centering element and the torque transmission contour, in particular the torque transmission face, of the torque transmission element enclose the angle on a side of the torque transmission element and the centering element facing the inner delimiting contour. Preferably, the centering contour, in particular the centering face, of the centering element has a straight, in particular flat, course. The centering contour, in particular the centering face, of the centering element preferably runs in a plane extending transversely, in particular at least essentially vertically, to the outer delimiting contour. Preferably, the torque transmission contour, in particular the torque transmission face, of the torque transmission element has a straight, in particular flat, profile. The torque transmission contour, in particular the torque transmission face, of the torque transmission element preferably runs in a plane extending transversely, in particular at least essentially vertically, to the outer delimiting contour. The centering contour, in particular the centering face, of the centering element and the torque transmission contour, in particular the torque transmission face, of the torque transmission element are preferably disposed in a region between two axial securing elements at the connection interface, in particular viewed along the peripheral direction. The design of the tool interface device according to the invention can advantageously enable secure contact of the rotary entrainment element with the torque transmission element and reliable centering. By design, a self-centering function can easily be achieved in a state of the tool interface device secured to the quick clamping device. An advantageously precise alignment of the tool interface device and thus of an insertion tool provided with the tool interface device on the quick clamping device can be achieved. It can advantageously enable safe and precise operation of a tool interface device and thus of an insertion tool provided with the tool interface device on a machine tool.

It is further proposed that the centering contour, in particular the centering face, of the centering element and the torque transmission contour, in particular the torque transmission face, of the torque transmission element are each disposed at an angle to a transverse axis, in particular a radial axis, of the connection interface, which extends at least essentially perpendicular to an axis of rotation, in particular the axis of rotation of the connection interface already mentioned above. Preferably, the centering contour, in particular the centering face, of the centering element and the torque transmission contour, in particular the torque transmission face, of the torque transmission element each form an angle with the transverse axis that is smaller than 170°, in particular smaller than 130° and preferably smaller than 90°. Preferably, an angle that the centering contour, in particular the centering face, of the centering element makes with the transverse axis is greater than an angle that the torque transmission contour, in particular the torque transmission face, of the torque transmission element makes with the transverse axis. By designing the tool interface device according to the invention, a torque transmission face can be easily created, in particular in order to realize a positive fit between the torque transmission element and the rotary entrainment element along the peripheral direction in a state of the tool interface device secured to the quick clamping device. Reliable centering can be made possible. By design, a self-centering function can easily be achieved in a state of the tool interface device secured to the quick clamping device. An advantageously precise alignment of the tool interface device and thus of an insertion tool provided with the tool interface device on the quick clamping device can be achieved. It can advantageously enable safe and precise operation of a tool interface device and thus of an insertion tool provided with the tool interface device on a machine tool.

In addition, it is proposed that the centering contour, in particular the centering face, of the centering element and a transverse axis, in particular a radial axis, of the connection interface, in particular the aforementioned transverse axis, in particular the aforementioned radial axis, which runs at least essentially perpendicular to an axis of rotation, in particular the aforementioned axis of rotation, of the connection interface, form an angle which is less than 90°, in particular less than 85°. In particular, the centering contour, especially the centering face, of the centering element and the transverse axis include an angle that has a value from a value range of 88° to 70°, preferably from 85° to 80°. The design of the tool interface device according to the invention can advantageously enable reliable centering. By design, a self-centering function can easily be achieved in a state of the tool interface device secured to the quick clamping device. An advantageously precise alignment of the tool interface device and thus of an insertion tool provided with the tool interface device on the quick clamping device can be achieved. It can advantageously enable safe and precise operation of a tool interface device and thus of an insertion tool provided with the tool interface device on a machine tool.

It is further proposed that the torque transmission contour, in particular the torque transmission face, of the torque transmission element and a transverse axis, in particular a radial axis, of the connection interface, in particular the aforementioned axis, which extends at least essentially perpendicular to an axis of rotation, in particular the aforementioned axis of rotation, of the connection interface, form an angle which is less than 50°, in particular less than 35°. In particular, the torque transmission contour, especially the torque transmission face, of the torque transmission element and the transverse axis include an angle which has a value from a value range of 10° to 40°, preferably from 20° to 35°. By designing the tool interface device according to the invention, a torque transmission face can be easily created, in particular in order to realize a positive fit between the torque transmission element and the rotary entrainment element along the peripheral direction in a state of the tool interface device secured to the quick clamping device. It can advantageously enable safe and precise operation of a tool interface device and thus of an insertion tool provided with the tool interface device on a machine tool.

It is further proposed that the centering contour, in particular the centering face, of the centering element is disposed on a side facing away from the torque transmission contour, in particular the torque transmission face, of the torque transmission element, in particular along a peripheral direction, in particular along the aforementioned peripheral direction of the connection interface, adjacent to an outer delimiting contour, in particular the aforementioned outer delimiting face, of the connection interface. A tangent of the outer delimiting contour running through a point of intersection between the outer delimiting contour and the centering contour includes with the centering contour in particular an angle which is smaller than 170°, preferably smaller than 165°, preferably smaller than 160° and which particularly preferably has a value from a value range between 140° and 160°. The embodiment according to the invention can advantageously realize a largely automatic self-centering function in a state of the tool interface device secured to the quick clamping device as a result of a torque acting on the tool interface device in a structurally simple and reliable manner.

It is also proposed that the tool interface device comprises at least one compensating unit which has at least one compensating element, which is disposed in a close region of the centering contour, in particular the centering face, of the centering element and/or the torque transmission contour, in particular the torque transmission face, of the torque transmission element and is in particular elastically deformable, and which is provided for damping torque shocks and/or for compensating for manufacturing tolerances. A “close region” is to be understood in particular as a region that has a maximum distance to a reference element or a reference point that is in particular less than 20 mm, preferably less than 10 mm and particularly preferably greater than 1 mm. Preferably, the close region has a maximum distance to the centering contour, in particular to the centering face, of the centering element and/or to the torque transmission contour, in particular to the torque transmission face, of the torque transmission element, which is in particular less than 10 mm, preferably less than 5 mm and particularly preferably greater than 1 mm. The compensating element is preferably disposed on the axial securing element. Preferably, the compensating unit has a large number of compensating elements, in particular a number of compensating elements analogous to the number of axial securing elements. Preferably, one compensating element is provided for each axial securing element. However, it is also conceivable that a number of compensating elements other than a single compensating element is disposed on the respective axial securing element for each axial securing element. The design of the tool interface device according to the invention can advantageously enable safe and precise operation of a tool interface device and thus of an insertion tool provided with the tool interface device on a machine tool. By design, a self-centering function can easily be achieved in a state of the tool interface device secured to the quick clamping device. Advantageously, when the tool interface device is secured to the quick clamping device, a largely automatic self-centering function can be implemented as a result of a torque acting on the tool interface device. An advantageously precise alignment of the tool interface device and thus of an insertion tool provided with the tool interface device on the quick clamping device can be achieved.

Furthermore, it is proposed that the compensating element is designed as a spring-elastic extension or as a material weakening in the connection interface. If the compensating element is designed as a material weakening, it is conceivable that the compensating element extends completely through a maximum material thickness of the connection interface, such as in the form of a continuous bore or the like, or is only partially inserted into the material thickness, such as in the form of a depression, a groove or the like. If the compensating element is designed as a spring-elastic extension, the compensating element can be introduced into the connection interface by means of a laser cutting process, introduced into the connection interface by means of a punching process during manufacture of the connection interface or introduced into the connection interface in another manner which appears to a person skilled in the art to be appropriate. For example, the compensating element is designed as a spring-elastic extension in the form of a spring leg, which has a freely movable end. The freely movable end can be bent in the direction of the outer delimiting contour or form a U-shape in order to influence a spring rate. Other designs of the compensating element that would appear useful to a person skilled in the art are also conceivable. The design of the tool interface device according to the invention makes it easy to integrate a damping function into the connection interface. It can advantageously enable safe and precise operation of a tool interface device and thus of an insertion tool provided with the tool interface device on a machine tool. By design, a self-centering function can easily be achieved in a state of the tool interface device secured to the quick clamping device. Advantageously, when the tool interface device is secured to the quick clamping device, a largely automatic self-centering function can be implemented as a result of a torque acting on the tool interface device. An advantageously precise alignment of the tool interface device and thus of an insertion tool provided with the tool interface device on the quick clamping device can be achieved.

It is further proposed that the connection interface has more than four centering elements, wherein a respective centering contour, in particular a respective centering face, of the centering elements, which in a state of the connection interface disposed on the quick clamping device rests against the quick clamping device, is disposed at an angle relative to the, in particular outer, delimiting contour of the connection interface. Advantageously, a self-centering function in a state of the tool interface device secured to the quick clamping device can be easily achieved by design and at the same time a fluttering of the insertion tool, in particular in the form of a saw blade, can be effectively counteracted in a state disposed on the quick clamping device.

It is also proposed that the centering contour, in particular the centering face, of the centering element, in particular viewed along a radial direction, preferably the aforementioned radial direction, is disposed at a distance from an inner delimiting contour, in particular the aforementioned inner delimiting contour, of the connection interface. The radial direction is preferably perpendicular to the axis of rotation of the connection interface. Preferably, the centering contour, in particular the centering face, of the centering element, preferably viewed along the radial direction, is disposed on a side of the inner delimiting contour facing away from the axis of rotation at a distance from the inner delimiting contour. Advantageously, a particularly favorable leverage ratio for the self-centering function can be easily achieved by design. A particularly efficient and reliable self-centering function of the connection interface can be realized.

Furthermore, it is proposed that the centering contour, in particular the centering face, of the centering element has a curved shape. Preferably, the centering contour, in particular the centering face, has a curved shape, at least when viewed along the peripheral direction of the connection interface. In particular, the centering contour, preferably the centering face, has a curved shape when viewed in the hub plane. It is conceivable that the centering contour, in particular the centering face, is concave or convex, preferably with respect to the axis of rotation. Alternatively, it is also conceivable that the centering contour, in particular the centering face, is at least partially convex and/or at least partially concave. Manufacturing tolerances can be compensated for particularly easily and effectively. Advantageously, a particularly precise and reliable self-centering function can be achieved in a state of the tool interface device secured to the quick clamping device.

It is also proposed that the centering contour, in particular the centering face, of the centering element is convex. Alternatively or additionally, it is also conceivable that a connecting face of the rotary entrainment element is curved, in particular convex or concave. Preferably, the connecting face and the centering contour only touch at one point. Manufacturing tolerances can be compensated for particularly easily and effectively. Advantageously, a particularly precise and reliable self-centering function can be achieved in a state of the tool interface device secured to the quick clamping device.

It is also proposed that the connection interface comprises at least one, in particular the aforementioned, torque transmission element for transmitting a torque in a state of the connection interface disposed on the quick clamping device, wherein the torque transmission element has a, preferably the previously mentioned, torque transmission contour, in particular a torque transmission face, which rests on the quick clamping device in a state of the connection interface disposed on the quick clamping device, wherein the torque transmission contour, in particular the torque transmission face, is at least partially formed in one piece with the centering contour, in particular the centering face, of the centering element. Preferably, the centering contour, in particular the centering face, and the torque transmission contour, in particular the torque transmission face, have a common uniform course. Preferably, the centering contour and the torque transmission contour have an identical curvature, wherein this can in particular also be understood to mean a curvature-free, in particular rectilinear, design of the torque transmission contour and the centering contour. Preferably, the torque transmission contour runs parallel to the centering contour, in particular at least when the centering contour and the torque transmission contour are formed without curvature, preferably at least viewed along the peripheral direction of the connection interface. Preferably, the torque transmission contour, in particular the torque transmission face, is formed by the centering contour, in particular the centering face. The centering contour, in particular the centering face, corresponds particularly preferably to the torque transmission contour, in particular the torque transmission face. A connection interface with a self-centering function can be implemented in a simple and particularly compact design.

In addition, an insertion tool, in particular a grinding wheel or cut-off wheel, with a tool interface device according to the invention is proposed. The tool interface device designed as an insertion tool hub can be connected to a tool base body of the insertion tool in a manner already known to a person skilled in the art, such as by means of a welded connection, by means of an adhesive connection, by means of a riveted connection, by means of a combination of at least two of the aforementioned connections or the like. Preferably, machining elements of the insertion tool, such as grinding elements or cutting elements, are disposed on the tool base body. The machining elements can have any design of grinding elements or cutting elements that would appear to a person skilled in the art to be useful and, in particular, can be manufactured and/or disposed on the tool base body by means of manufacturing processes that are well known to a person skilled in the art. The design according to the invention makes it easy to achieve a self-centering function in a state of the insertion tool secured to the quick clamping device. An advantageously precise alignment of the insertion tool on the quick clamping device can be achieved. It is advantageous to counteract an imbalance when the insertion tool rotates. Safe and precise operation of the insertion tool on a machine tool can be made possible.

Furthermore, a machine tool system with at least one portable machine tool, which has a tool holder, and with at least one insertion tool according to the invention, which can be fastened to the tool holder in a rotationally fixed and axially secured manner, is proposed. The term “portable machine tool” is in this context understood to mean a machine tool for machining workpieces, the machine tool able to be transported and/or held by an operator without the need for a transport machine. In particular, the portable machine tool has a mass that is less than 40 kg, preferably less than 10 kg, and more preferably less than 5 kg. Preferably, the portable machine tool is designed as an angle grinder. However, it is also conceivable that the portable machine tool has another configuration that would appear useful to a person skilled in the art, such as a configuration as a circular saw, as an oscillating machine tool, as a grinding machine or the like. The embodiment according to the invention can advantageously counteract an imbalance during rotation of the insertion tool. The portable machine tool can be operated safely and precisely.

The tool interface device according to the invention, the insertion tool according to the invention and/or the machine tool system according to the invention should not be limited to the application and embodiment described above. In particular, the tool interface device according to the invention, the insertion tool according to the invention and/or the machine tool system according to the invention can/can have a number of individual elements, components and units that differs from a number specified herein in order to fulfill a mode of operation described herein.

### DRAWINGS

Further advantages follow from the description of the drawings hereinafter. Five exemplary embodiments of the invention are shown in the drawing. The drawings, the description, and the claims contain numerous features in combination. A person skilled in the art will appropriately also consider the features individually and combine them into additional advantageous combinations.

### Here:

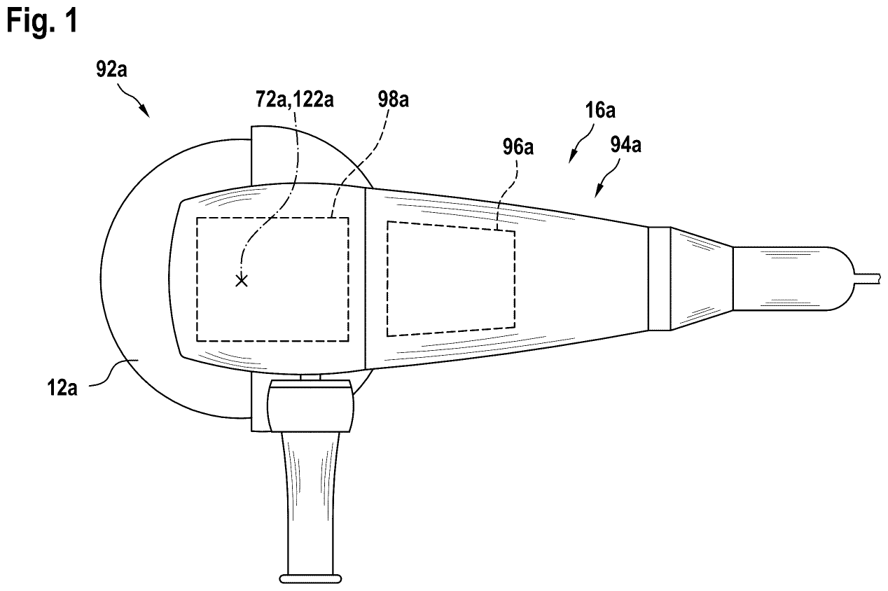

FIG. 1 shows a schematic view of a machine tool system according to the invention with a portable machine tool and with an insertion tool according to the invention disposed on a tool holder of the portable machine tool,

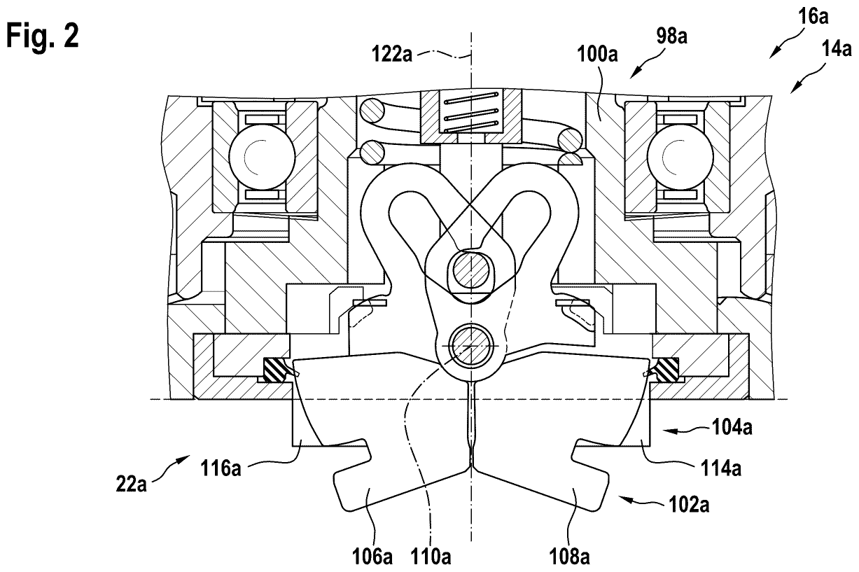

FIG. 2 shows a schematic view of a section through the tool holder, which comprises a quick clamping device,

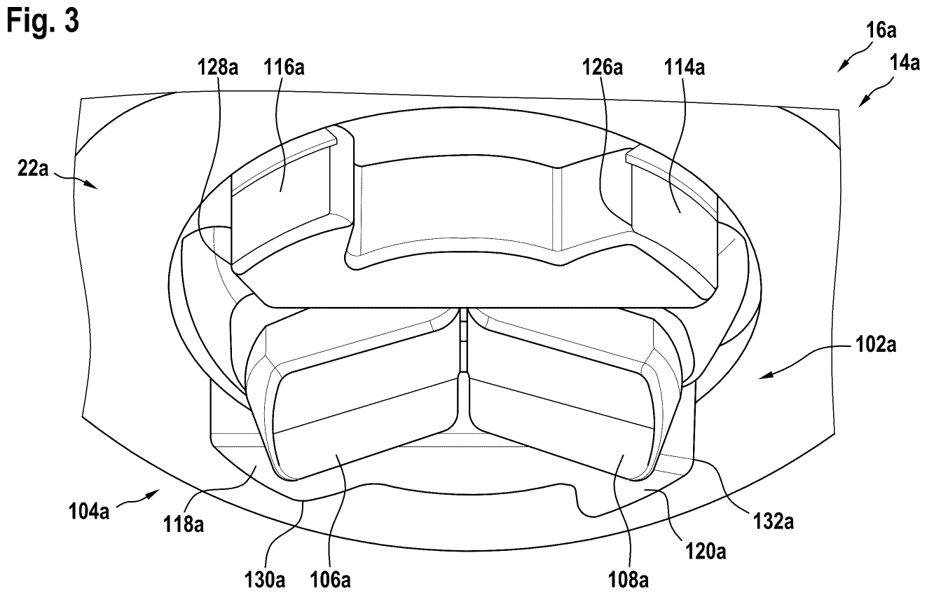

FIG. 3 shows a schematic, perspective view of the quick clamping device in an open state,

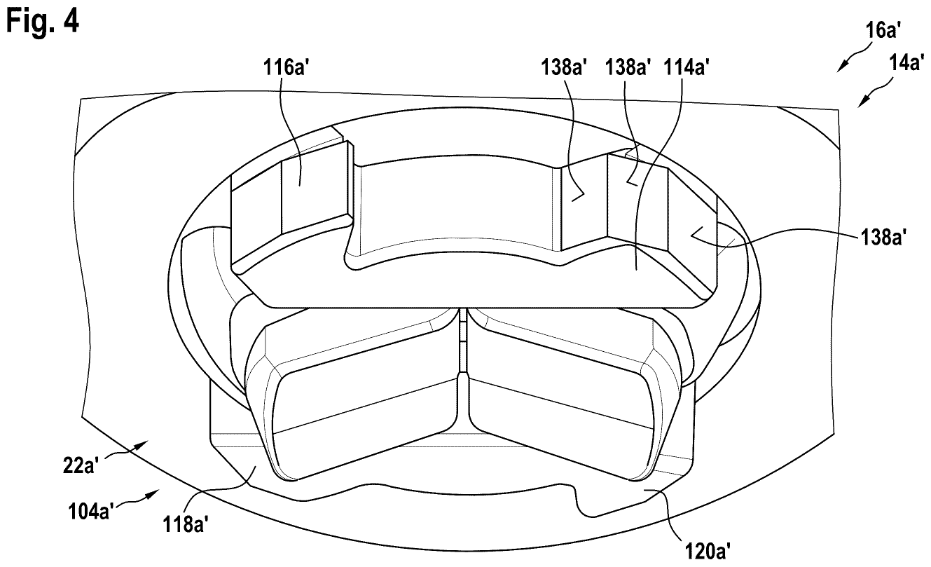

FIG. 4 shows a schematic, perspective view of an alternative quick clamping device in an open state,

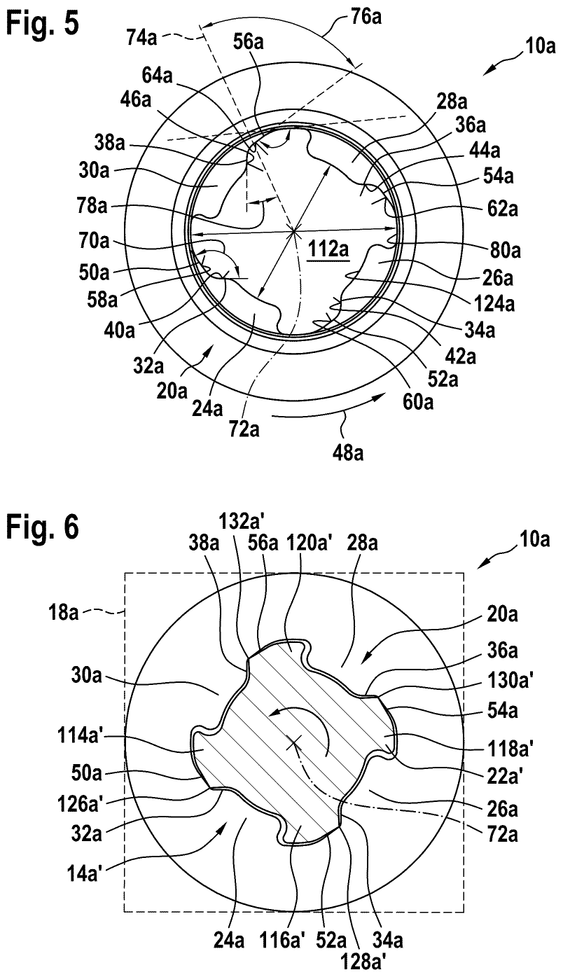

FIG. 5 shows a schematic view of a tool interface device according to the invention of the insertion tool according to the invention,

FIG. 6 shows a schematic sectional view of the tool interface device according to the invention and the quick clamping device in a state of the tool interface device according to the invention disposed on the alternative quick clamping device,

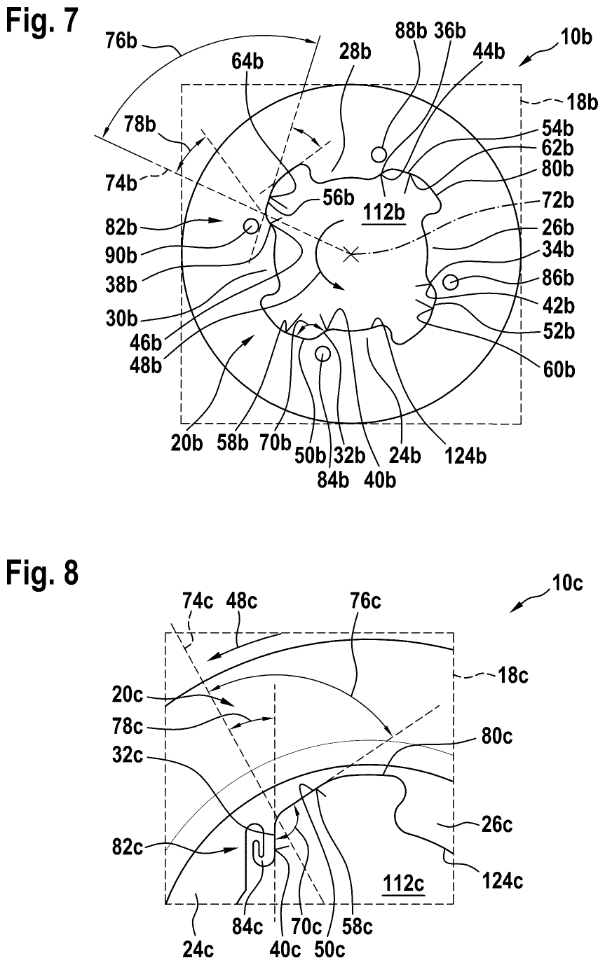

FIG. 7 shows a schematic sectional view of a first alternative tool interface device according to the invention and the quick clamping device in a state of the first alternative tool interface device according to the invention disposed on the quick clamping device,

FIG. 8 shows a schematic detailed view of a second alternative tool interface device according to the invention,

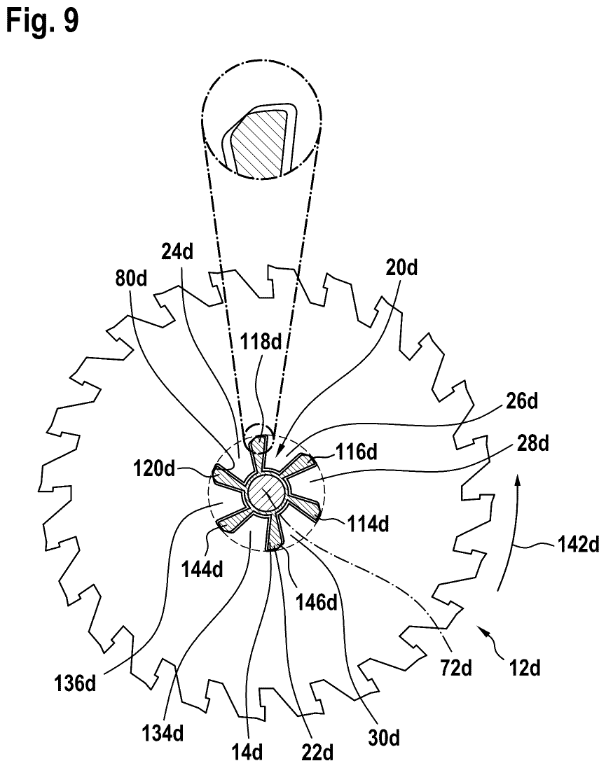

FIG. 9 shows a schematic view of a third alternative tool interface device according to the invention and a quick clamping device in a state of the third alternative tool interface device according to the invention disposed on the quick clamping device,

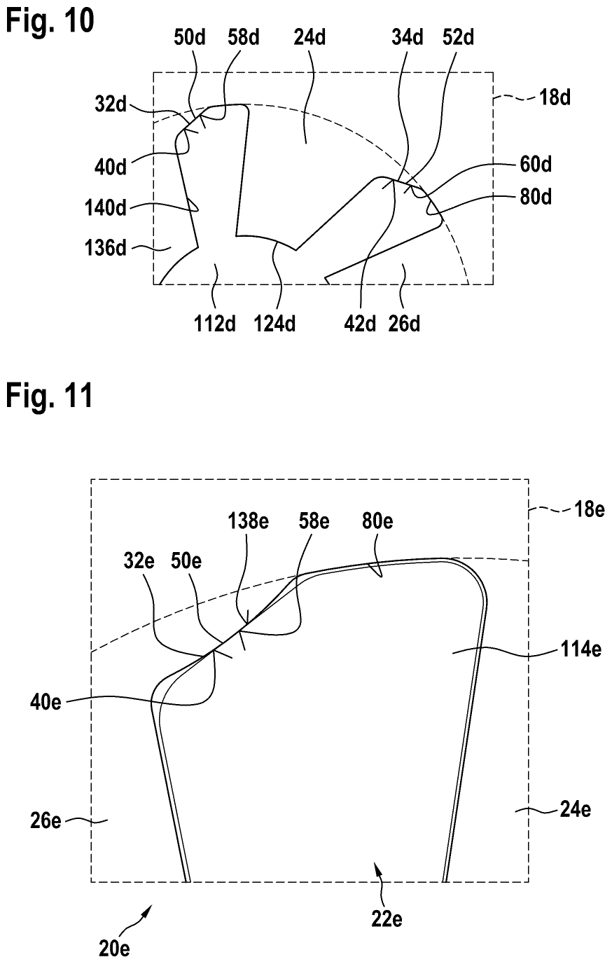

FIG. 10 shows a schematic partial view of the third alternative tool interface device according to the invention from FIG. 9 without the quick clamping device and

FIG. 11 shows a schematic sectional view of a fourth alternative tool interface device according to the invention and a quick clamping device in a state of the fourth alternative tool interface device according to the invention disposed on the quick clamping device.

### DESCRIPTION OF THE EXEMPLARY EMBODIMENTS

FIG. 1 shows a machine tool system 92a, which comprises at least one portable machine tool 16a, which has a tool holder 14a (see FIGS. 2 and 3), and which comprises at least one insertion tool 12a, which in the exemplary embodiment shown in FIG. 1 is fastened to the tool holder 14a in a rotationally fixed and axially secured manner. The portable machine tool 16a is designed as an angle grinder. Alternatively, it is conceivable that the portable machine tool 16a is designed as a circular sawing machine, a multifunction machine tool or the like. The tool holder 14a comprises a quick clamping device 22a (see FIGS. 2 and 3). By means of the quick clamping device 22a, a tool interface device 10a (see FIGS. 5 and 6) of the insertion tool 12a can be fastened to the tool holder 14a in a rotationally fixed and axially secured manner. The tool interface device 10a is designed as an insertion tool hub. In FIG. 1, the insertion tool 12a is exemplarily designed as a grinding wheel. Alternatively, it is conceivable that the insertion tool 12a is designed as a cut-off wheel or the like. The tool interface device 10a is connected to a tool base body of the insertion tool 12a by means of a connection method already known to a person skilled in the art. The portable machine tool 16a has a housing unit 94a. The portable machine tool 16a comprises a drive unit 96a and an output unit 98a, which are disposed in the housing unit 94a. The drive unit 96a is provided to drive the output unit 98a in a manner already known to a person skilled in the art. The output unit 98a comprises an output spindle 100a, on which the tool holder 14a is disposed. The tool interface device 10a, in particular the insertion tool 12a, can be driven to rotate about an output axis 122a of the output spindle 100a by means of the output spindle 100a in a state disposed on the quick clamping device 22a.

FIG. 2 shows the quick clamping device 22a in a schematic sectional view. The quick clamping device 22a comprises a clamping device 102a. The clamping device 102a is movably mounted on the output spindle 100a. The clamping device 102a is provided to axially secure the insertion tool 12a to the output spindle 100a. The clamping device 102a comprises a clamping jaw 106a and a further clamping jaw 108a for axially securing the tool interface device 10a to the output spindle 100a. The clamping jaw 106a and the further clamping jaw 108a are designed as hook jaws. The clamping jaw 106a and the further clamping jaw 108a are essentially analogous to one another. The clamping jaw 106a and the further clamping jaw 108a are mounted so as to be movable relative to one another, in particular pivotable about a pivot axis 110a. The clamping jaw 106a and the further clamping jaw 108a have a common pivot axis 110a. However, it is also conceivable that the clamping jaw 106a and the further clamping jaw 108a have different pivot axes. The pivot axis 110a of the clamping device 102a, in particular of the clamping jaw 106a and the further clamping jaw 108a, extends in a plane extending transversely, in particular essentially perpendicularly, to the output axis 122a. The pivot axis 110a of the clamping device 102a forms a clamping device pivot axis.

The clamping jaw 106a and the further clamping jaw 108a are designed to be movable relative to one another, in particular pivotable about the pivot axis 110a, in an angular range of up to 50°, preferably of up to 40°, preferably of up to 30°, particularly preferably of up to 20°. The clamping device 102a or the clamping jaw 106a and the further clamping jaw 108a can have two states. The clamping device 102a or the clamping jaw 106a and the further clamping jaw 108a can have a fastened state or a released state. In a fastened state, the clamping jaw 106a and the further clamping jaw 108a are extended in a radial direction oriented away from the output axis 122a, in particular such that the clamping jaw 106a and the further clamping jaw 108a occupy a maximum radial extension relative to one another in an extended state. In a fastened state, the clamping jaw 106a and the further clamping jaw 108a are preferably connected to the tool interface device 10a. In a fastened state, the clamping jaw 106a and the further clamping jaw 108a are in engagement with the tool interface device 10a as a result of a movement of the clamping jaw 106a and the further clamping jaw 108a in the radial direction of the output axis 122a. The tool interface device 10a can be held frictionally and/or non-positively on the portable machine tool 16a, in particular on the tool holder 14a, by means of the clamping jaw 106a and the further clamping jaw 108a. In a fastened state, the tool interface device 10a is form-fittingly connected to the quick clamping device 22a in the axial direction of the output axis 122a. In a released state, the clamping device 102a, in particular the clamping jaw 106a and the further clamping jaw 108a, is retracted in a radial direction relative to the output axis 122a such that the clamping device 102a, in particular the clamping jaw 106a and the further clamping jaw 108a, has a maximum radial extension along a direction extending essentially perpendicular to the output axis 122a, which is smaller than a minimum radial extension of a through-opening 112a of the tool interface device 10a. The clamping device 102a, in particular the clamping jaw 106a and the further clamping jaw 108a, can be transferred from a released state to a fastened state by inserting the tool interface device 10a in the axial direction of the output axis 122a into the quick clamping device 22a. FIG. 2 shows the clamping jaw 106a and the further clamping jaw 108a in a released state.

The quick clamping device 22a comprises a rotary entrainment unit 104a. The rotary entrainment unit 104a has at least one rotary entrainment element 114a, 116a, 118a, 120a, in particular four rotary entrainment elements 114a, 116a, 118a, 120a, disposed in particular on the clamping device 102a (see FIGS. 2 and 3). The at least one rotary entrainment element 114a, 116a, 118a, 120a is provided for transmitting a rotary movement of the quick clamping device 22a to the tool interface device 10a. The rotary entrainment unit 104a preferably has rotary entrainment elements 114a, 116a, 118a, 120a that are symmetrical to one another. In particular, the rotary entrainment elements 114a, 116a, 118a, 120a are disposed evenly distributed along a peripheral direction 48a on the tool holder 14a.

The quick clamping device 22a is provided for fastening the tool interface device 10a, in particular the insertion tool 12a with the tool interface device 10a, to the tool holder 14a, in particular without tools. The tool interface device 10a, in particular the insertion tool 12a with the tool interface device 10a, can be driven in rotation by the output spindle 100a in a state of the tool interface device 10a, in particular the insertion tool 12a with the tool interface device 10a, secured to the tool holder 14a by means of the quick clamping device 22a.

FIG. 4 shows an embodiment of an alternative tool holder 14a′ with a quick clamping device 22a′. The quick clamping device 22a′ comprises a rotary entrainment unit 104a′. The rotary entrainment unit 104a′ has at least one rotary entrainment element 114a′, 116a′, 118a′, 120a′, in particular four rotary entrainment elements 114a′, 116a′, 118a′, 120a′. The quick clamping device 22a′ is designed identically to the quick clamping device 22a of FIGS. 2 and 3, except for the differences described. The rotary entrainment elements 114a′, 116a′, 118a′, 120a′ each have three connecting faces 138a′, which are designed in particular to correspond to a connection interface 20a of the tool interface device 10a (in FIG. 4, the connecting faces 138a′ are provided with reference signs only for the rotary entrainment element 114a′ as an example). The three connecting faces 138a′ are adjacent to each other. The three connecting faces 138a′ are disposed at an angle to each other in this example.

Alternatively, the tool holder 14a can comprise a quick clamping device for connection to the tool interface device 10a, as disclosed, for example, in WO 2021/130026 A1. The disclosure content of WO 2021/130026 A1 with regard to the quick clamping device disclosed therein is to be regarded in particular as part of the present description with regard to the alternative embodiment of the tool holder 14a. In contrast to the quick clamping device according to WO 2021/130026 A1, it is also conceivable that the quick clamping device has a rotary entrainment unit according to the rotary entrainment unit 104 or the rotary entrainment unit 104a′.

FIG. 5 shows a detailed view of the tool interface device 10a, wherein the tool base body of the insertion tool 12a is not shown. The tool interface device 10a, which is designed in particular as an insertion tool hub, is provided for connecting the insertion tool 12a to the tool holder 14a of the portable machine tool 16a, the tool holder 14a′ or the like. The tool interface device 10a comprises at least one connection interface 20a, in particular disposed completely in a hub plane 18a (shown dashed in FIG. 6), for a frictional and/or form-fitting connection with the quick clamping device 22a of the tool holder 14a or the quick clamping device 22a′, wherein the connection interface 20a comprises at least one axial securing element 24a, 26a, 28a, 30a, in particular at least one clamping face, for axial securing on the quick clamping device 22a or the quick clamping device 22a′. Furthermore, the tool interface device 10a comprises, in particular in at least one embodiment, at least one torque transmission element 32a, 34a, 36a, 38a for a transmission of a torque in a state of the connection interface 20a disposed at the quick clamping device 22a or the quick clamping device 22a′. The axial securing element 24a, 26a, 28a, 30a is preferably designed as a clamping extension, in particular as a clamping wing. The axial securing element 24a, 26a, 28a, 30a extends in a plane extending at least essentially perpendicular to an axis of rotation 72a of the connection interface 20a, preferably starting from an outer delimiting contour 80a of the connection interface 20a to an inner delimiting contour 124a of the connection interface 20a. The connection interface 20a preferably comprises two, in particular three and preferably four axial securing elements 24a, 26a, 28a, 30a, which are disposed offset relative to one another along the peripheral direction 48a. In particular, the axial securing elements 24a, 26a, 28a, 30a are evenly distributed along the peripheral direction 48a. However, it is also conceivable that the connection interface 20a has a number of axial securing elements 24a, 26a, 28a, 30a that differs from two, three or four and/or that the axial securing elements 24a, 26a, 28a, 30a are disposed unevenly distributed along the peripheral direction 48a. The axial securing element(s) 24a, 26a, 28a, 30a is/are preferably provided for a frictional and/or non-positive connection along a direction extending at least essentially parallel to the axis of rotation 72a with the quick clamping device 22a or the quick clamping device 22a′.

The torque transmission element 32a, 34a, 36a, 38a has a torque transmission contour, in particular a torque transmission face 40a, 42a, 44a, 46a, which, in a state of the connection interface 20a disposed on the quick clamping device 22a, rests against the quick clamping device 22a, in particular against at least one of the rotary entrainment elements 114a, 116a, 118a, 120a. Preferably, the connection interface 20a comprises at least two, in particular three and preferably four torque transmission elements 32a, 34a, 36a, 38a, which are disposed offset relative to one another along the peripheral direction 48a. In particular, the torque transmission elements 32a, 34a, 36a, 38a are evenly distributed along the peripheral direction 48a. However, it is also conceivable that the connection interface 20a has a number of torque transmission elements 32a, 34a, 36a, 38a that differs from two, three or four and/or that the torque transmission elements 32a, 34a, 36a, 38a are disposed unevenly distributed along the peripheral direction 48a. In particular, a number of torque transmission elements 32a, 34a, 36a, 38a is dependent on a number of rotary entrainment elements 114a, 116a, 118a, 120a of the quick clamping device 22a. Preferably, a number of torque transmission elements 32a, 34a, 36a, 38a corresponds to a number of rotary entrainment elements 114a, 116a, 118a, 120a. However, it is also conceivable that the number of torque transmission elements 32a, 34a, 36a, 38a is not equal to the number of rotary entrainment elements 114a, 116a, 118a, 120a, in particular an integer multiple or a fraction of a number of rotary entrainment elements 114a, 116a, 118a, 120a.

The torque transmission face 40a, 42a, 44a, 46a of the torque transmission element 32a, 34a, 36a, 38a preferably extends at least essentially parallel to the axis of rotation 72a. In particular, a main plane of extension of the axial securing element 24a, 26a, 28a, 30a, in particular the clamping face, extends transversely, in particular at least essentially perpendicularly, to the axis of rotation 72a. The main plane of extension of the axial securing element 24a, 26a, 28a, 30a, in particular the clamping face, preferably extends transversely, in particular at least essentially perpendicularly, to a centering face 58a, 60a, 62a, 64a of a centering element 50a, 52a, 54a, 56a and/or to the torque transmission face 40a, 42a, 44a, 46a of the torque transmission element 32a, 34a, 36a, 38a. The torque transmission elements 32a, 34a, 36a, 38a preferably all have an analogous configuration, so that a description of a single torque transmission element 32a, 34a, 36a, 38a applies to all torque transmission elements 32a, 34a, 36a, 38a.

At least one, in particular at least two and preferably at least three, of the rotary entrainment elements 114a, 116a, 118a, 120a, of the quick clamping device 20a lies/lie in particular, preferably with a centering point 126a, 128a, 130a, 132a of the rotary entrainment element(s) 114a, 116a, 118a, 120a, in a state of the connection interface 20a disposed on the quick clamping device 22a, lies against one of the centering contours, in particular the centering faces 58a, 60a, 62a, 64a, of the centering elements 50a, 52a, 54a, 56a. The centering point 126a, 128a, 130a, 132a on a rotary entrainment element 114a, 116a, 118a, 120a is preferably defined as the point of intersection between a transmission face of the rotary entrainment element 114a, 116a, 118a, 120a, which faces the torque transmission contour, in particular the torque transmission face 40a, 42a, 44a, 46a, of the torque transmission element 32a, 34a, 36a, 38a, and an outer edge of the rotary entrainment element 114a, 116a, 118a, 120a, which faces the outer delimiting contour 80a.

The connection interface 20a comprises at least the centering element 50a, 52a, 54a, 56a, which in particular adjoins the torque transmission element 32a, 34a, 36a, 38a along the peripheral direction 48a of the connection interface 20a, wherein a centering contour, in particular a centering face 58a, 60a, 62a, 64a, of the centering element 50a, 52a, 54a, 56a, which in a state of the connection interface 20a disposed on the quick clamping device 22a rests against the quick clamping device 22a, is disposed at an angle relative to the torque transmission contour, in particular the torque transmission face 40a, 42a, 44a, 46a, of the torque transmission element 32a, 34a, 36a, 38a. Preferably, the connection interface 20a comprises at least two, in particular three and preferably four centering elements 50a, 52a, 54a, 56a, which are disposed offset relative to one another along the peripheral direction 48a. In particular, the centering elements 50a, 52a, 54a, 56a are evenly distributed along the peripheral direction 48a. However, it is also conceivable that the connection interface 20a has a number of centering elements 50a, 52a, 54a, 56a that differs from two, three or four and/or that the centering elements 50a, 52a, 54a, 56a are disposed unevenly distributed along the peripheral direction 48a. The connection interface 20a has at least the centering element 50a, 52a, 54a, 56a, wherein a centering contour, in particular a centering face 58a, 60a, 62a, 64a of the centering element 50a, 52a, 54a, 56a, which in a state of the connection interface 20a disposed on the quick clamping device 22a rests against the quick clamping device 22a, wherein the centering contour, in particular the centering face 58a, 60a, 62a, 64a, of the centering element 50a, 52a, 54a, 56a is disposed at an angle relative to the, in particular outer, delimiting contour 80a, in particular delimiting face, of the connection interface 20a, which delimits the through-opening 112a of the connection interface 20a. In at least one embodiment of the tool interface device 10a, it is conceivable that the centering element 50a, 52a, 54a, 56a is provided solely for transmitting a torque in a state of the connection interface 20a disposed on the quick clamping device 22a. In particular, it is conceivable that in at least the above-mentioned alternative embodiment of the tool interface device 10a, a centering function and a torque transmission function can be fulfilled by the centering element 50a, 52a, 54a, 56a. It is preferably conceivable that in at least the above-mentioned alternative embodiment of the tool interface device 10a, the torque transmission element 32a, 34a, 36a, 38a in a state of the connection interface 20a disposed on the quick clamping device 22a is disposed at a distance along the peripheral direction 48a relative to the quick clamping device 22a during operation of the portable machine tool 16a and can only be brought into contact with the quick clamping device 22a when a maximum torque is exceeded, in particular to realize a torque shock protection function. In at least the above-mentioned alternative embodiment of the tool interface device 10a, operating torques could be transmitted solely by the centering element 50a, 52a, 54a, 56a, in particular by resting against the quick clamping device 22a.

The axial securing elements 24a, 26a, 28a, 30a, the torque transmission elements 32a, 34a, 36a, 38a and the centering elements 50a, 52a, 54a, 56a preferably all extend in the hub plane 18a. In particular, the hub plane 18a intersects the axial securing elements 24a, 26a, 28a, 30a, the torque transmission elements 32a, 34a, 36a, 38a and the centering elements 50a, 52a, 54a, 56a. The axial securing elements 24a, 26a, 28a, 30a, the torque transmission elements 32a, 34a, 36a, 38a and the centering elements 50a, 52a, 54a, 56a are preferably formed in one piece with one another, in particular as a result of a laser cutting process or as a result of a stamping process from a sheet metal component blank. However, it is also conceivable that the axial securing elements 24a, 26a, 28a, 30a, the torque transmission elements 32a, 34a, 36a, 38a and the centering elements 50a, 52a, 54a, 56a are joined together by means of a material-locking connection method after individual production of the individual elements.

The centering elements 50a, 52a, 54a, 56a preferably all have an analogous design, so that a description of an individual centering element 50a, 52a, 54a, 56a applies to all centering elements 50a, 52a, 54a, 56a. The centering element 50a, 52a, 54a, 56a is preferably disposed adjacent to the outer delimiting contour 80a of the connection interface 20a, which delimits the through-opening 112a of the connection interface 20a, in particular when viewed along the peripheral direction 48a of the connection interface 20a. Preferably, the centering contour, in particular the centering face 58a, 60a, 62a, 64a, of the centering element 50a, 52a, 54a, 56a is disposed at an angle relative to the outer delimiting contour 80a. The outer delimiting contour 80a is preferably designed as a pitch circle contour. The through-opening 112a of the connection interface 20a is preferably provided for a feed-through of the quick clamping device 22a or alternatively of an output threaded spindle, in particular one already known to a person skilled in the art. The connection interface 20a has the inner delimiting contour 124a, which delimits the through-opening 112a. The inner delimiting contour 124a is preferably formed as a pitch circle contour. In particular, the outer delimiting contour 80a is disposed on a circle having a diameter that is larger than a diameter of a circle on which the inner delimiting contour 124a is disposed. The inner delimiting contour 124a is preferably disposed on a circle having a maximum diameter of 16 mm. The outer delimiting contour 80a is preferably disposed on a circle that has a maximum diameter of 21.5 mm. However, it is also conceivable that, if the insertion tool 12a is designed as a circular saw blade (not shown here in detail), the outer delimiting contour 80a is preferably disposed on a circle that has a maximum diameter of 36.5 mm. The outer delimiting contour 80a is preferably disposed concentrically to the inner delimiting contour 124a about the axis of rotation 72a.

The centering contour, in particular the centering face 58a, 60a, 62a, 64a, of the centering element 50a, 52a, 54a, 56a and the torque transmission contour, in particular the torque transmission face 40a, 42a, 44a, 46a, of the torque transmission element 32a, 34a, 36a, 38a include an angle 70a which is smaller than 180°, in particular smaller than 150°. In particular, the centering contour, in particular the centering face 58a, 60a, 62a, 64a, of the centering element 50a, 52a, 54a, 56a and the torque transmission contour, in particular the torque transmission face 40a, 42a, 44a, 46a, of the torque transmission element 32a, 34a, 36a, 38a include the angle 70a, which is smaller than 140° and preferably has a value from a value range of 90° to 135° Preferably, the centering contour, in particular the centering face 58a, 60a, 62a, 64a, of the centering element 50a, 52a, 54a, 56a and the torque transmission contour, in particular the torque transmission face 40a, 42a, 44a, 46a, of the torque transmission element 32a, 34a, 36a, 38a form the angle 70a on a side of the torque transmission element 32a, 34a, 36a, 38a and the centering element 50a, 52a, 54a, 56a facing the inner delimiting contour 124a. Preferably, the centering contour, in particular the centering face 58a, 60a, 62a, 64a, of the centering element 50a, 52a, 54a, 56a has a straight, in particular flat, course. The centering contour, in particular the centering face 58a, 60a, 62a, 64a, of the centering element 50a, 52a, 54a, 56a preferably extends in a plane extending transversely, in particular at least essentially perpendicularly, to the outer delimiting contour 80a. Preferably, the torque transmission contour, in particular the torque transmission face 40a, 42a, 44a, 46a, of the torque transmission element 32a, 34a, 36a, 38a has a straight, in particular flat, course. The torque transmission contour, in particular the torque transmission face 40a, 42a, 44a, 46a, of the torque transmission element 32a, 34a, 36a, 38a preferably extends in a plane extending transversely, in particular at least essentially perpendicularly, to the outer delimiting contour 80a. The centering contour, in particular the centering face 58a, 60a, 62a, 64a, of the centering element 50a, 52a, 54a, 56a and the torque transmission contour, in particular the torque transmission face 40a, 42a, 44a, 46a, of the torque transmission element 32a, 34a, 36a, 38a are preferably disposed in a region between two axial securing elements 24a, 26a, 28a, 30a at the connection interface 20a, in particular viewed along the peripheral direction 48a.

The centering contour, in particular the centering face 58a, 60a, 62a, 64a, of the centering element 50a, 52a, 54a, 56a and the torque transmission contour, in particular the torque transmission face 40a, 42a, 44a, 46a, of the torque transmission element 32a, 34a, 36a, 38a are each disposed at an angle to a transverse axis 74a, in particular a radial axis, of the connection interface 20a, which extends at least essentially perpendicular to the axis of rotation 72a of the connection interface 20a. Preferably, the centering contour, in particular the centering face 58a, 60a, 62a, 64a, of the centering element 50a, 52a, 54a, 56a and the torque transmission contour, in particular the torque transmission face 40a, 42a, 44a, 46a, of the torque transmission element 32a, 34a, 36a, 38a each include an angle (not shown here in more detail) with the transverse axis 74a which is less than 170°, in particular less than 130° and preferably less than 90°. Preferably, an angle which the centering contour, in particular the centering face 58a, 60a, 62a, 64a, of the centering element 50a, 52a, 54a, 56a makes with the transverse axis 74a is greater than an angle which the torque transmission contour, in particular the torque transmission face 40a, 42a, 44a, 46a, of the torque transmission element 32a, 34a, 36a, 38a makes with the transverse axis 74a.

The centering contour, in particular the centering face 58a, 60a, 62a, 64a, of the centering element 50a, 52a, 54a, 56a and the transverse axis 74a, in particular the radial axis, of the connection interface 20a, which extends at least essentially perpendicular to the axis of rotation 72a of the connection interface 20a, include an angle 76a which is less than 90°, in particular less than 85°. In particular, the centering contour, in particular the centering face 58a, 60a, 62a, 64a, of the centering element 50a, 52a, 54a, 56a and the transverse axis 74a include the angle 76a, which has a value from a value range of 88° to 70°, preferably from 85° to 80°.

The torque transmission contour, in particular the torque transmission face 40a, 42a, 44a, 46a, of the torque transmission element 32a, 34a, 36a, 38a and the transverse axis 74a, in particular the radial axis, of the connection interface 20a, which extends at least essentially perpendicular to the axis of rotation 72a of the connection interface 20a, include an angle 78a which is smaller than 50°, in particular smaller than 35°. In particular, the torque transmission contour, in particular the torque transmission face 40a, 42a, 44a, 46a, of the torque transmission element 32a, 34a, 36a, 38a and the transverse axis 74a include the angle 78a, which has a value from a value range of 10° to 40°, preferably from 20° to 35°.

The centering contour, in particular the centering face 58a, 60a, 62a, 64a, of the centering element 50a, 52a, 54a, 56a is disposed on a side facing away from the torque transmission contour, in particular torque transmission face 40a, 42a, 44a, 46a, of the torque transmission element 32a, 34a, 36a, 38a, in particular along the peripheral direction 48a of the connection interface 20a, adjacent to the, in particular outer, delimiting contour 80a, in particular delimiting face, of the connection interface 20a. A tangent of the outer delimiting contour 80a extending through a point of intersection between the outer delimiting contour 80a and the centering contour, in particular the centering face 58a, 60a, 62a, 64a, of the centering element 50a, 52a, 54a, 56a closes with the centering contour, in particular the centering face 58a, 60a, 62a, 64a, of the centering element 50a, 52a, 54a, 56a, preferably forms an angle which is smaller than 170°, preferably smaller than 165°, preferably smaller than 160° and which particularly preferably has a value from a value range between 140° and 160°.

FIG. 6 shows a detailed view of the tool interface device 10a during assembly on the quick clamping device 22a′ from below—i.e., a top view in the direction of the portable machine tool 16a—wherein the quick clamping device 22a′ is shown in section. In the position of the tool interface device 10a relative to the quick clamping device 22a′ shown in FIG. 6, the rotary entrainment elements 114a′, 116a′, 118a′, 120a′ are disposed in regions between the axial securing elements 24a, 26a, 28a, 30a and are, in particular still, spaced from the torque transmitting contours, in particular from the torque transmitting faces 40a, 42a, 44a, 46a, of the torque transmitting elements 32a, 34a, 36a, 38a. At least one, in particular at least two and preferably at least three, of the rotary entrainment elements 114a′, 116a′, 118a′, 120a′ lies, in particular lie, preferably with a centering point 126a′, 128a′, 130a′, 132a′ of the rotary entrainment element(s) 114a′, 116a′, 118a′, 120a′, rests against one of the centering contours, in particular the centering faces 58a, 60a, 62a, 64a, of the centering elements 50a, 52a, 54a, 56a. The centering point 126a′, 128a′, 130a′, 132a′ on a rotary entrainment element 114a′, 116a′, 118a′, 120a′ is preferably defined as the point of intersection between a transmission face, in particular at least one of the connecting faces 138a′, of the rotary entrainment element 114a′, 116a′, 118a′, 120a′, which faces the torque transmission contour, in particular the torque transmission face 40a, 42a, 44a, 46a, of the torque transmission element 32a, 34a, 36a, 38a, and an outer edge of the rotary entrainment element 114a′, 116a′, 118a′, 120a′, which faces the outer delimiting contour 80a. As a result of applying a torque to the quick clamping device 22a′, a relative movement between the tool interface device 10a and the quick clamping device 22a′ can be caused, which can result in the centering point 126a′, 128a′, 130a′, 132a′ sliding along the centering contour, in particular the centering face 58a, 60a, 62a, 64a, of the centering element 50a, 52a, 54a, 56a, until the transmission face of the rotary entrainment element 114a′, 116a′, 118a′, 120a′ rests against the torque transmission contour, in particular the torque transmission face 40a, 42a, 44a, 46a, of the torque transmission element 32a, 34a, 36a, 38a. As a result of an inclination of the centering contour, in particular the centering face 58a, 60a, 62a, 64a, of the centering element 50a, 52a, 54a, 56a relative to the outer delimiting contour 80a, a distance between centering points 126a′, 128a′, 130a′, 132a′, which do not yet rest against one of the centering contours, in particular the centering face 58a, 60a, 62a, 64a, of the centering elements 50a, 52a, 54a, 56a, after the tool interface device 10a has been slid onto the quick clamping device 22a′, and the centering contours, in particular the centering faces 58a, 60a, 62a, 64a, of the centering elements 50a, 52a, 54a, 56a, becomes smaller thanks to a rotary movement of the tool interface device 10a relative to the quick clamping device 22a′ about the axis of rotation 72a. The centering points 126a′, 128a′, 130a′, 132a′ are thus preferably pressed against the centering contours, in particular the centering faces 58a, 60a, 62a, 64a, of the centering elements 50a, 52a, 54a, 56a, so that a self-centering function can be advantageously implemented. Preferably, in a state of the quick-action clamping device 22a′ in which the transmission faces of the rotary entrainment elements 114a′, 116a′, 118a′, 120a′ rest against the torque transmission contours, in particular the torque transmission faces 40a, 42a, 44a, 46a, of the torque transmission elements 32a, 34a, 36a, 38a, at least three centering points 126a′, 128a′, 130a′, 132a′ rest against the centering contours, in particular the centering faces 58a, 60a, 62a, 64a, of the centering elements 50a, 52a, 54a, 56a.

FIGS. 7 through 11 show further exemplary embodiments of the invention. The following descriptions and the drawings are limited essentially to the differences between the exemplary embodiments, wherein, with respect to identically named components, in particular with respect to components having identical reference signs, reference can in principle also be made to the drawings and/or the description of the other exemplary embodiments, in particular of FIGS. 1 through 6. To distinguish between the exemplary embodiments, the letter a has been placed after the reference signs of the exemplary embodiment in FIGS. 1 through 6. In the exemplary embodiments of FIGS. 7 through 11, the letter a is replaced by letters b to e.

FIG. 7 shows an alternative tool interface device 10b, in particular an insertion tool hub, for an insertion tool for connecting the insertion tool to a tool holder (not shown here in detail) of a machine tool, in particular a portable machine tool (not shown here in detail). The tool interface device 10b comprises at least one connection interface 20b, in particular disposed completely in a hub plane 18b, for a frictional and/or form-fitting connection with a quick clamping device (not shown here) of the tool holder, wherein the connection interface 20b has at least one axial securing element 24b, 26b, 28b, 30b, in particular a clamping face, for axial securing on the quick clamping device and at least one torque transmission element 32b, 34b, 36b, 38b for transmitting a torque in a state of the connection interface 20b disposed on the quick clamping device, wherein the torque transmission element 32b, 34b, 36b, 38b has a torque transmission contour, in particular a torque transmission face 40b, 42b, 44b, 46b, which rests against the quick clamping device in a state of the connection interface 20b disposed on the quick clamping device. The connection interface 20b comprises at least one centering element 50b, 52b, 54b, 56b, in particular adjoining the torque transmission element 32b, 34b, 36b, 38b along a peripheral direction 48b of the connection interface 20b, wherein a centering contour, in particular a centering face 58b, 60b, 62b, 64b, of the centering element 50b, 52b, 54b, 56b, which in a state of the connection interface 20b disposed on the quick clamping device rests against the quick clamping device, is disposed at an angle relative to the torque transmission contour, in particular the torque transmission face 40b, 42b, 44b, 46b, of the torque transmission element 32b, 34b, 36b, 38b.

In particular, in contrast to the exemplary embodiment shown and described in FIGS. 1 to 6, the tool interface device 10b shown in FIG. 7 has at least one compensating unit 82b which is disposed in a close region of the centering contour, in particular the centering face 58b, 60b, 62b, 64b, of the centering element 50b, 52b, 54b, 56b and/or the torque transmission contour, in particular the torque transmission face 40b, 42b, 44b, 46b, of the torque transmission element 32b, 34b, 36b, 38b, which has an elastically deformable compensating element 84b, 86b, 88b, 90b, which is provided for damping torque surges and/or for compensating manufacturing tolerances. The compensating element 84b, 86b, 88b, 90b is formed as a material weakening in the connection interface 20b. In total, the compensating unit 82b comprises four compensating elements 84b, 86b, 88b, 90b, which are designed and disposed analogously to one another. However, it is also conceivable that the compensating unit 82b has a number of compensating elements 84b, 86b, 88b, 90b that differs from four, which are formed and disposed analogously to one another or which are formed differently from one another and are disposed unevenly at the connection interface 20b.

FIG. 8 shows a further alternative tool interface device 10c, in particular an insertion tool hub, for an insertion tool 12c for connecting the insertion tool 12c to a tool holder (not shown here in detail) of a machine tool, in particular a portable machine tool (not shown here in detail). The tool interface device 10c comprises at least one connection interface 20c, in particular disposed completely in a hub plane 18c, for a frictional and/or form-fitting connection to a quick clamping device (not shown here in more detail) of the tool holder, wherein the connection interface 20c comprises at least one axial securing element 24c, 26c, in particular a clamping face for axial securing on the quick clamping device and at least one torque transmission element 32c for transmitting a torque in a state of the connection interface 20c disposed on the quick clamping device, wherein the torque transmission element 32c has a torque transmission contour, in particular a torque transmission face 40c, which rests against the quick clamping device in a state of the connection interface 20c disposed on the quick clamping device. The connection interface 20c comprises at least one centering element 50c, in particular adjoining the torque transmission element 32c along a peripheral direction 48c of the connection interface 20c, wherein a centering contour, in particular a centering face 58c, of the centering element 50c, which in a state of the connection interface 20c disposed on the quick clamping device rests against the quick clamping device, is disposed at an angle relative to the torque transmission contour, in particular the torque transmission face 40c, of the torque transmission element 32c.

In particular in contrast to the exemplary embodiment shown and described in FIGS. 1 through 6, the tool interface device 10c shown in FIG. 8 has at least one compensating unit 82c, which has at least one compensating element 84c disposed in a close region of the centering contour, in particular the centering face 58c, of the centering element 50c and/or the torque transmission contour, in particular the torque transmission face 40c, of the torque transmission element 32c, which is provided for damping torque surges and/or for compensating for manufacturing tolerances. The compensating element 84c is designed as a spring-elastic extension. In total, the compensating unit 82c comprises four compensating elements 84c, which are designed and disposed analogously to one another. However, it is also conceivable that the compensating unit 82c has a number of compensating elements 84c other than four, which are formed and disposed analogously to one another or which are formed differently from one another and are disposed unevenly at the connection interface 20c.

FIG. 9 shows a tool interface device 10d, in particular an insertion tool hub, for an insertion tool 12d for connecting the insertion tool to a tool holder 14d of a machine tool, in particular a portable machine tool (not shown here in detail). The tool interface device 10d comprises at least one connection interface 20d, in particular disposed completely in a hub plane 18d, for a frictional and/or form-fitting connection with a quick clamping device 22d of the tool holder 14d (see also FIG. 10). FIG. 9 shows the tool interface device 10d during assembly on the quick clamping device 22d from below—i.e., a top view in the direction of the portable machine tool—wherein the quick clamping device 22d is shown in section. The connection interface 20d comprises at least one axial securing element 24d, 26d, 28d, 30d, 134d, 136d, in particular a clamping face, for axial securing to the quick clamping device 22d.

The connection interface 20d has at least one centering element 50d, 52d. The connection interface 20d has more than four centering elements 50d, 52d. The connection interface 20d has six centering elements 50d, 52d. Alternatively, however, it is also conceivable that the connection interface 20d has a number of centering elements 50d, 52d other than six, for example one, two, three, four, five or more than six centering elements 50d, 52d. A respective centering contour, in particular a respective centering face 58d, 60d, of the centering elements 50d, 52d, which in a state of the connection interface 20d disposed on the quick clamping device 22d rests against the quick clamping device 22d, is disposed at an angle relative to an outer delimiting contour 80d of the connection interface 20d.

The centering contours, in particular centering faces 58d, 60d, of the centering elements 50d, 52d are disposed at a distance from an inner delimiting contour 124d of the connection interface 20d, in particular when viewed along a radial direction. The radial direction is perpendicular to an axis of rotation 72d of the connection interface 20d. The centering contours, in particular the centering faces 58d, 60d, of the centering elements 50d, 52d are disposed, preferably viewed along the radial direction, on a side of the inner delimiting contour 124d facing away from the axis of rotation 72d and at a distance from the inner delimiting contour 124d.

The connection interface 20d comprises six torque transmitting members 32d, 34d for transmitting a torque in a state of the connection interface 20d disposed at the quick clamping device 22d. Alternatively, however, it is also conceivable that the connection interface 20d has a number of torque transmission elements 32d, 34d other than six, for example one, two, three, four, five or more than six torque transmission elements 32d, 34d. The torque transmission elements 32d, 34d each have a torque transmission contour, in particular torque transmission face 40d, 42d.

The quick clamping device 22d here comprises, by way of example, six rotary entrainment elements 114d, 116d, 118d, 120d, 144d, 146d. Preferably, a number of rotary entrainment elements 114d, 116d, 118d, 120d, 144d, 146d corresponds to a number of torque transmitting elements 32d, 34d. Alternatively, however, it is also conceivable that the number of rotary entrainment elements 114d, 116d, 118d, 120d, 144d, 146d is different from the number of torque transmitting elements 32d, 34d, in particular is less than the number of torque transmitting elements 32d, 34d. Preferably, the quick clamping device 22d for axially securing the insertion tool 12d has a retaining element according to WO 2021/130026 A1 with six retaining wings corresponding to the connection interface 20d (not shown here).

In each case, one of the torque transmission contours, in particular the torque transmission faces 40d, 42d, is at least partially integral with one of the centering contours, in particular the centering faces 58d, 60d, of the centering elements 50d, 52d. One of the centering contours, in particular the centering faces 58d, 60d, and one of the torque transmission contours, in particular the torque transmission faces 40d, 42d, have a common uniform profile. The centering contours and the torque transmission contours have an identical curvature, wherein a curvature-free, in particular rectilinear, design of the torque transmission contours and the centering contours can also be understood here in particular. In each case, one of the torque transmission contours, in particular the torque transmission faces 40d, 42d, is formed by one of the centering contours, in particular the centering faces 58d, 60d. Particularly preferably, one of the centering contours, in particular the centering faces 58d, 60d, corresponds in each case to one of the torque transmission contours, in particular the torque transmission faces 40d, 42d.

The centering faces 40d, 42d and a transverse axis (not shown here), in particular radial axis, of the connection interface 20d extending at least essentially perpendicularly to the axis of rotation 72d of the connection interface 20d include an angle which is less than 75°, in particular less than 65°, wherein the transverse axis preferably extends through a point of intersection of the respective centering face 40d, 42d with the outer delimiting contour 80d. A front centering element delimiting contour 140d adjoins the centering faces 40d, 42d, in particular in an intended direction of rotation 142d of the connection interface 20d (here, only one of the front centering element delimiting contours 140d is provided with a reference sign. The respective front centering element delimiting contour 140d is disposed at an angle to the respective centering face 40d, 42d. The centering faces 40d, 42d and the respective front centering element delimiting contour 140d include an angle which is preferably less than 120°. The front centering element delimiting contour 140d and a transverse axis (not shown here), in particular radial axis, of the connection interface 20d extending at least essentially perpendicularly to the axis of rotation 72d of the connection interface 20d include an angle which is smaller than 10°, wherein the transverse axis preferably extends through a point of intersection of the respective centering face 40d, 42d with the front centering element delimiting contour 140d.

FIG. 11 shows a tool interface device 10e, in particular an insertion tool hub, for an insertion tool for connecting the insertion tool to a tool holder 14e of a machine tool, in particular a portable machine tool (not shown here in detail). The tool interface device 10e comprises at least one connection interface 20e, in particular disposed completely in a hub plane 18e, for a frictional and/or form-fitting connection with a quick clamping device 22e of a tool holder. The connection interface 20e comprises at least one axial securing element 24e, 26e, in particular a clamping face, for axial securing to the quick clamping device 22e.

The connection interface 20e has at least one centering element 50e. The connection interface 20e has more than four centering elements 50e (only a section of the connection interface 20e is shown here, in which only one of the centering elements 50e is depicted). The connection interface 20e has six centering elements 50e, 52e. Alternatively, however, it is also conceivable that the connection interface 20e has a different number of centering elements 50e, 52e than six, for example one, two, three, four, five or more than six centering elements 50e, 52e. A respective centering contour, in particular a respective centering face 58e, 60e, of the centering elements 50e, 52e, which in a state of the connection interface 20e disposed on the quick clamping device 22e rests against the quick clamping device 22e, is disposed at an angle relative to an outer delimiting contour 80e of the connection interface 20e. The centering contours, in particular centering faces 58e, 60e, of the centering elements 50e, 52e are disposed at a distance from an inner delimiting contour 124e of the connection interface 20e, in particular when viewed along a radial direction.

The connection interface 20d comprises six torque transmitting elements 32e for transmitting a torque in a state of the connection interface 20e disposed at the quick clamping device 22e (only a section of the connection interface 20e is shown here, in which only one of the torque transmitting elements 32e is illustrated). Alternatively, however, it is also conceivable that the connection interface 20e has a number of torque transmission elements 32e other than six, for example one, two, three, four, five or more than six torque transmission elements 32e.

The torque transmission elements 32e each have a torque transmission contour, in particular torque transmission face 40e. In each case, one of the torque transmission contours, in particular the torque transmission faces 40e, is at least partially integral with one of the centering contours, in particular the centering faces 58e, of the centering elements 50e.

The centering contours, in particular the centering faces 58e, have a curved shape. The centering contours, in particular the centering faces 58e, have a curved course, at least when viewed along a peripheral direction of the connection interface 20e. The centering contours, in particular the centering faces 58e, have a curved shape when viewed in the hub plane 18e. The centering contours, in particular the centering faces 58e, are convex. Alternatively, it is also conceivable that the centering contours, in particular the centering faces 58e, are concave-convex. Alternatively, it is also conceivable that the centering contours, in particular the centering faces 58e, are at least partially convex and/or at least partially concave. Alternatively or additionally, it is also conceivable that a connecting face 138e of a rotary entrainment element 114e of the connection interface is curved, in particular convex or concave. Particularly preferably, the connecting face 138e and the centering contour only touch at one point.

1. A tool interface device for an insertion tool for connection of the insertion tool to a tool holder of a machine tool, the tool interface device comprising:
at least one connection interface configured for a frictional and/or form-fitting connection with a quick clamping device of the tool holder, the at least one connection interface comprising:
at least one axial securing element configured for axial securing on the quick clamping device; and
at least one centering element having a centering contour, which in a first state of the connection interface disposed on the quick clamping device rests against the quick clamping device, is disposed at an angle relative to a through-opening of the at least one connection interface.

2. The tool interface device according to claim 1, wherein:
the at least one connection interface further comprises at least one torque transmission element configured to transmit a torque in the first state of the connection interface, the torque transmission element having a torque transmission contour, which in the first state rests against the quick clamping device,
the at least one centering element adjoins the torque transmission element,
the centering contour is disposed at an angle relative to the torque transmission contour.

3. The tool interface device according to claim 2, wherein the centering contour and the torque transmission contour enclose an angle which is less than 180°.

4. The tool interface device according to claim 2, wherein the centering contour, of the centering element and the torque transmission contour of the torque transmission element are each disposed at an angle to a transverse axis of the connection interface extending at least essentially perpendicular to an axis of rotation of the connection interface.

5. The tool interface device according to claim 1, wherein the centering contour and a transverse axis of the connection interface extending at least essentially perpendicular to an axis of rotation of the connection interface form an angle which is less than 90°.

6. The tool interface device according to claim 2, wherein the torque transmission contour and a transverse axis of the connection interface extending at least essentially perpendicularly to an axis of rotation of the connection interface form an angle which is smaller than 50°.

7. The tool interface device according to claim 2, wherein the centering contour is disposed on the torque transmission contour and is disposed adjacent to a delimiting contour of the connection interface.

8. The tool interface device according to claim 2, further comprising:
at least one compensating unit disposed in a close region of the centering contour and/or the torque transmission contour, the at least one compensating unit configured to damp torque surges and/or to compensate for manufacturing tolerances.

9. The tool interface device according to claim 8, wherein the compensating element is designed as a spring-elastic extension or as a material weakening in the connection interface.

10. The tool interface device according to claim 1, wherein:
the at least one centering element includes more than four centering elements, and
a respective centering contour of each of the more than four centering elements, which in the first state rests against the quick clamping device, is disposed at an angle relative to the delimiting contour of the connection interface.

11. The tool interface device according to claim 1, wherein the centering contour is disposed at a distance from an inner delimiting contour of the connection interface when viewed along a radial direction.

12. The tool interface device according to claim 1, wherein the centering contour has a curved course.

13. The tool interface device according to claim 1, wherein the centering contour is convex.

14. The tool interface device according to claim 1, wherein:
the connection interface further comprises at least one torque transmission element configured to transmit a torque in the first state of,
the torque transmission element, which in the first state, rests against the quick clamping device, and
the torque transmission contour is formed at least partially in one piece with the centering contour of the centering element.

15. An insertion tool comprising:
a tool interface device configured to connect the insert tool to a tool holder of a machine tool, the tool interface device comprising:
at least one connection interface configured for a frictional and/or form-fitting connection with a quick clamping device of the tool holder, the at least one connection interface comprising:
at least one axial securing element configured for axial securing on the quick clamping device; and
at least one centering element having a centering contour, which in a first state of the connection interface disposed on the quick clamping device rests against the quick clamping device, is disposed at an angle relative to a through-opening of the at least one connection interface.

16. A machine tool system comprising:
at least one portable machine tool comprising a tool holder; and
at least one insertion tool having a tool interface device comprising:
at least one connection interface configured for a frictional and/or form-fitting connection with a quick clamping device of the tool holder, the at least one connection interface including:
at least one axial securing element configured for axial securing on the quick clamping device; and
at least one centering element having a centering contour, which in a first state of the connection interface disposed on the quick clamping device rests against the quick clamping device, is disposed at an angle relative to a through-opening of the at least one connection interface,
wherein the at least one insertion tool is configured to fix to the tool holder in a rotationally fixed and axially secured manner via the tool interface device.

17. The tool interface device according to claim 1, wherein:
the tool interface device is an insertion tool hub,
the tool interface device is configured to connect to a portable machine tool,
the at least one connection interface is disposed completely in a hub plane,
the at least one axial securing element is a clamping face,
the centering contour is a centering face, and
in the first state, the centering contour is disposed at an angle relative to an outer delimiting contour or a delimiting face of the connection interface.

18. The tool interface device according to claim 2, wherein:
the torque transmission contour is a torque transmission face, and
the at least one centering element adjoins the torque transmission element along a peripheral direction.

19. The tool interface device according to claim 3, wherein:
a centering face of the centering contour is disposed at an angle relative to the torque transmission face, and
the centering face and the torque transmission face enclose an angle that is less than 150°.

20. The tool interface device according to claim 4, wherein:
a centering face of the centering element and a torque transmission face of the torque transmission contour are each disposed at the angle, and
the transverse axis is a radial axis.
